(19) United States
(12) Patent Application Publication
(10) Pub. No.: US 2013/0146427 A1
(43) Pub. Date: Jun. 13, 2013

(54) Belt Conveyor Clamping Apparatus, System & Method

(71) Applicant: Kimberley Grant Greirson, Kelmscott (AU)

(72) Inventor: Kimberley Grant Greirson, Kelmscott (AU)

(73) Assignee: SPECIALISED MACHINERY COMPANY PTY LTD, Canning Vale (AU)

(21) Appl. No.: 13/818,387

(22) PCT Filed: Aug. 23, 2011
(86) PCT No.: PCT/AU2011/001079

§ 371 Date: Feb. 22, 2013

(30) Foreign Application Priority Data
Aug. 23, 2010 (AU) 2010903764

(51) Int. Cl. B65G 21/00

(52) U.S. Cl. CPC B65G 21/00
USPC 198/837

(57) ABSTRACT

An automated clamping assembly adapted for mounting on or adjacent to a belt conveyor. The clamping assembly includes a clamping member selectively movable between an operative position in which the clamping member is disposed on or closely adjacent to a conveyor belt to retain the belt in a rest position during adverse weather conditions, and an inoperative position in which the clamping member is disposed away from the belt so as not to impede normal operation of the conveyor. An automated drive mechanism is adapted to move the clamping member between the operative and inoperative positions. A control module is adapted to activate the drive mechanism in response to activation control signals from a remote system controller. The control module also is adapted to send feedback control signals to the system controller indicative of the clamping status of the clamping member.

### FIELD OF THE INVENTION

The present invention relates generally to belt conveyors of the type used for transportation of bulk materials and more specifically to clamping assemblies, systems and methods for locking down such belt conveyors in adverse weather conditions. The invention has been developed primarily for use in large-scale conveyors adapted for bulk handling and transportation of coal, mineral ores, grains and other solid or granular materials in exterior locations and will be described predominantly in this context. It should be appreciated, however, that the invention is not limited to these particular fields of use.

### BACKGROUND OF THE INVENTION

The following discussion of the prior art is intended to place the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Belt conveyors are known for use in the handling and transportation of bulk materials such as coal, minerals and mineral ores of various types including silicates, carbonates, sulphates, halides, oxides, sulphides and phosphates, as well as native metals, inter-metallic elements, non-metals, organic minerals, and other suitable materials such as grains, agricultural chemicals and fertilisers.

A belt conveyor usually consists of two primary head pulleys and a belt in the form of a continuous loop extending between and around the head pulleys. The belt is supported at intermediate locations by subsidiary rollers or idler pulleys. One or both of the head pulleys are driven, so as to progressively move the belt and hence the bulk material supported on the belt, from one place to another.

Such belt conveyors are used in a wide variety of industrial applications, for example for stockpiling materials in and around mining and minerals processing operations, moving materials between different operations or stages within processing plants, and loading or unloading ships, trucks, rail cars and the like at ports or other bulk freight transfer stations. In large-scale operations, typical belt conveyor runs can extend from many hundreds of meters to several kilometres in length, sometimes in adjoining sections or segments. In many such applications, the conveyor belt is positioned wholly or at least partially outdoors and is therefore directly exposed to prevailing weather conditions, including particularly to wind and rain, and potentially to cyclonic storm conditions.

In storms, cyclones or hurricanes, it is usually necessary to temporarily tie down, clamp or otherwise restrain the conveyor belt at intervals along its length. This lockdown operation is required in order to prevent the belt from lifting, resulting in loss of bulk material from the belt as well as potential damage to the belt and other components of the conveyor system, which in turn can lead to significant maintenance and repair expenses as well as costly plant downtime.

As a basic solution to this problem, it is known to use a series of chains or ropes at spaced apart locations in order to tie down conveyor belts. However, this is a cumbersome, time-consuming, inefficient and sometimes ineffective method. It is also subject to a high risk of human error, in the sense that if even one chain is inadvertently overlooked during the removal process, the resultant damage upon start-up can put the entire conveyor out of action for many hours or even days, while costly repairs take place.

It is also known to use dedicated manual clamping devices which are carried into position and deployed at closely spaced intervals along the length of the belt, as and when required for conveyor lock-down operations in advance of impending storm conditions. However, while such devices are somewhat more reliable than chains or ropes, they are typically also time-consuming and hence expensive to install. Moreover, once the storm conditions have passed, it is necessary to reverse the entire process by manually removing all of the clamping devices before the conveyor can be restarted. This inevitably results in additional labour expense and further hours of costly downtime.

There are also significant safety issues arising from both of these known techniques, due to the need for clamping operators to work quickly in typically wet, dirty and slippery conditions, often at significant heights above the ground.

In an attempt to overcome these difficulties, some clamping devices have been designed to be permanently mounted at intervals along the length of the conveyor in an inoperative position adjacent the belt. Such devices are intended to remain in situ and the clamping operation is performed by manually moving each clamp into an operative position when required.

This arrangement saves some time by avoiding the need to first carry the clamps themselves into position when required for use. However, the clamping activation process remains a time-consuming, labour-intensive manual operation. For example, on a relatively large-scale belt conveyor installation, it may be necessary to deploy 200 to 300 clamps along the length of the belt, and each such clamp typically requires around 2 to 3 minutes to activate. Hence, the belt clamping operation can take many hours (typically at least 5) to complete, even with the clamps already in situ and with a significant number of skilled operators working simultaneously on the lockdown operation. There may also be several conveyors to be locked down. It therefore remains a time-consuming and expensive procedure and if storm conditions arrive quickly or unexpectedly as can frequently occur in some operating environments, there may be inadequate time to complete the clamping operation before significant damage is done. And again, the whole process must be reversed once the storm conditions have passed.

Thus, even with clamping devices in situ, it is not unusual to encounter 4 to 6 hours of lost production on either side of a storm, cyclone or hurricane as a result of the conveyor clamping and lockdown process. The cumulative cost of this lost production can amount to many millions of dollars per year on a single site. Moreover, this method remains subject to many of the same safety hazards for workers, as previously discussed.

These permanently positioned clamping devices have also tended to be relatively bulky, and typically cannot be accommodated in many belt conveyor installations due to the inherent spatial constraints. Furthermore, such systems give rise to high maintenance costs, due to the need for each clamp to be individually inspected in situ at periodic intervals. These clamping devices also remain subject to the risk of one or more of the individual clamps being inadvertently overlooked during the de-clamping process. As previously noted, this inevitably occurs from time to time due to operator error, particularly on large-scale conveyor installations, and often results in significant costly damage to both the clamping device and the belt when the conveyor is restarted. This can result in several days of additional downtime for the conveyor while the resultant damage is repaired, at considerable expense.

It is an object of the present invention to overcome or substantially ameliorate one or more of the deficiencies of the prior art, or at least to provide a useful alternative.

### SUMMARY OF THE INVENTION

Accordingly, in a first aspect, the invention provides an automated clamping assembly adapted for mounting on or adjacent a belt conveyor, the clamping assembly including:

a clamping member selectively movable between an operative position in which the clamping member is disposed on or closely adjacent a conveyor belt to retain the belt in a rest position during adverse weather conditions, and an inoperative position in which the clamping member is disposed away from the conveyor belt so as not to impede normal operation of the conveyor belt; and

an automated drive mechanism adapted to move the clamping member between the operative position and the inoperative position.

In some preferred embodiments, the clamping assembly includes a control module adapted to activate the drive means in response to activation control signals. The control module in some embodiments is preferably also adapted to generate feedback control signals indicative of the clamping status of the clamping member. For example, in some embodiments, the feedback control signals effectively verify when the clamp is in the operative position, and/or the inoperative position. In some embodiments, the feedback control signals may also include more detailed information regarding intermediate positions of the clamping arm between the operative and inoperative positions. In some embodiments, the feedback control signals also include information indicative of operating performance parameters of the drive mechanism or other operating parameters of the clamping assembly, such as instantaneous electrical current draw rate, on the basis of which errors signals are generated in the event of such parameters exceeding predetermined normal operating threshold levels.

Preferably, the clamping assembly further includes a manual drive mechanism operable independently, as a back-up or manual override for the automated drive mechanism, to effect manual movement of the clamping member between the operative and inoperative positions. In one preferred form, the manual drive mechanism is operable by means a rotary hand-wheel mechanism, integrated with the automated drive mechanism.

In one embodiment, the drive mechanism takes the form of an electric motor operable in conjunction with a reduction gearbox. It should be appreciated, however, that the drive mechanism may additionally or alternatively include an hydraulic motor or cylinder, a pneumatic motor or cylinder, an electromechanical actuator, a servo motor and/or other suitable drive means. In some embodiments, one drive mechanism may be adapted to activate multiple clamping assemblies simultaneously, either in primary or backup operational modes.

In one embodiment, the clamping member includes a clamping arm adapted in use to extend transversely across the conveyor belt, the clamping arm being supported for rotational movement about a generally horizontal transverse pivot axis between the operative and inoperative positions. In one form, the clamping arm has respective end sections that are substantially coaxial with the pivot axis, a central belt retaining section that is axially spaced from the pivot axis, and intermediate shoulder sections disposed on either side of the central section to connect the central section with the respective end sections. Preferably, in the operative position, the central belt retaining section is in contact with, or at least in close proximity to, the conveyor belt so as to prevent the belt from lifting in high wind conditions. Preferably, in this embodiment, the end sections are rotatably supported by respective coaxial bearing formations disposed on opposite sides of the belt.

In one form of this embodiment, the clamping arm is preferably shaped so as to allow bulk material on the belt to pass beneath the central section during normal operation of the conveyor, with the clamping assembly in the inoperative position. If the belt has inclined sides, the intermediate shoulder sections of the clamping arm are preferably inclined at generally corresponding angles, and are positioned closely adjacent the respective side regions of the belt, in the operative position. This form of the invention is particularly suited to long open type conveyors where no stackers run over the belt.

In another embodiment, the clamping member includes a relatively short clamping arm adapted in use to extend only partially across the conveyor belt, so as to clamp one side of the belt. Preferably, in this embodiment, the clamping assembly is adapted for use as one of a matched pair of like clamps disposed on opposite sides of the conveyor belt, with the respective clamping arms adapted for engagement with correspondingly opposite sides of the belt, in the operative position. If the belt has inclined sides, again, the arm of each clamping assembly is preferably inclined at a generally corresponding angle, in the operative position.

In one form of this embodiment, movement between the operative and inoperative positions involves pivotal movement of the clamping arm about orthogonal axes in at least two stages. The first stage of pivotal movement preferably involves rotational displacement about a generally horizontal transverse axis whereby the clamping arm is positioned above the corresponding side of the belt. The second stage of pivotal movement preferably involves subsequent rotational displacement about a generally vertical axis whereby the clamping arm is moved to one side of the belt. Preferably, the retraction process further involves a third stage of pivotal movement, whereby the clamping arm is subsequently rotationally displaced about a substantially horizontal axis generally aligned with the belt, and thereby lowered into a retracted inoperative position on the corresponding side of the belt.

In another embodiment, movement between the inoperative and inoperative positions involves a single stage of rotational displacement about a substantially horizontal axis which is generally parallel to the directional orientation of the belt.

In some embodiments, the clamping arm in the inoperative position is adapted to be retracted, in one or more phases of pivotal and/or translational displacement, so as to reside substantially within the confines of a supporting frame for the belt conveyor.

In some embodiments, the clamping assembly is adapted for retrofitting to existing belt conveyor installations. In other embodiments, the clamping assembly is designed to be fully integrated into the of the belt conveyor ab initio.

In a second aspect, the invention provides a clamping system including:

a plurality of clamping assemblies each as previously defined, adapted in use to be disposed in spaced apart relationship along a belt conveyor; and

a system controller adapted selectively to activate and deactivate the respective clamping assemblies, thereby automatically to regulate movement of each conveyor assembly between the operative and inoperative positions, by means of activation control signals.

In some preferred embodiments, the activation control signals are generated by the system controller in response to inputs from a human operator, for example via a main activation switch, control panel or other suitable user interface. In other embodiments, the activation control signals are additionally or alternatively generated by the system controller automatically in response to predetermined control parameters such as minimum threshold wind speed or wind loading conditions, forecast storm conditions, automated timing intervals, scheduled maintenance intervals, or the like.

In some embodiments, the clamping assemblies in the system are grouped, with each group being associated with a predetermined segment or section of the conveyor, and each group being independently controllable via the system controller. In some embodiments, each clamping assembly is individually controllable remotely via the system controller.

In some embodiments, the system controller is adapted to activate the respective clamping assemblies simultaneously. In some embodiments, the system controller is adapted to activate the respective clamping assemblies sequentially or progressively in groups or stages, so as to minimise electrical load spikes.

Preferably, the system controller is adapted to receive feedback control signals from the control modules associated with the respective clamping assemblies, and to provide an indication via a display terminal to an operator of the clamping status of the respective clamping assemblies. In one preferred embodiment, the display terminal provides a visual indication in relation to each clamping assembly, of when the respective clamping assembly is in the operative position and when the clamping assembly is in the inoperative position. It will be appreciated that this feedback mechanism allows a remote operator to readily determine if any of the clamping assemblies in the system is malfunctioning, and if so, which clamping assemblies are affected.

In some embodiments, the feedback control signals include additional information indicative of selected operational performance parameters of the drive mechanism or other operating parameters of the respective clamping mechanisms, such as instantaneous electrical current draw rate. Preferably, in such embodiments, the system controller is adapted to generate warning or error signals if such parameters extend beyond predetermined normal operating threshold levels. For example, abnormally high current draw may indicate a damaged drive motor or motor controller, and by means of this automatic control feedback loop, the operator's attention would be immediately drawn to the problem.

In a further aspect, the invention provides a method for remotely clamping a belt conveyor so as to lock down the conveyor in adverse weather conditions, the method including the steps of:

providing a clamping system as previously defined;

positioning the clamping assemblies of the system in spaced apart relationship along a section or segment of the conveyor, and

activating the system controller remotely so as to cause the clamping assemblies to move automatically between the operative and inoperative positions according to selective operator control inputs or predetermined control parameters.

### BRIEF DESCRIPTION OF THE DRAWINGS

Preferred embodiments of the invention will now be described, by way of example only, with reference to the accompanying drawings in which:

FIG. 1 is a perspective view of a clamping assembly according to a first embodiment of the invention;

FIG. 2 is a front elevation view showing the clamping assembly of FIG. 1, installed on a belt conveyor, in both the operative and inoperative positions (the inoperative position shown in ghost outline);

FIG. 3 is a perspective view showing a series of clamping assemblies of the type depicted in FIGS. 1 and 2, installed in spaced apart relationship along a section of a belt conveyor, each in the operative position;

FIG. 4 is a perspective view of a clamping assembly according to a second embodiment of the invention;

FIG. 5 is a front elevation view showing a matched pair of clamping assemblies of the type shown in FIG. 4, installed on a belt conveyor, in the operative position;

FIG. 6 is a front elevation view similar to FIG. 5, showing the matched pair of clamping assemblies in the inoperative position;

FIGS. 7A to 7D show a series of side elevation views of one of the clamping assemblies shown in FIGS. 5 and 6, depicting the progressive sequence of movements of the clamping arm from the operative to the inoperative position;

FIG. 8A is a perspective view showing the clamping assembly of FIGS. 4 to 7 in the operative position;

FIG. 8B is a perspective view similar to FIG. 8A, showing the same clamping assembly in the inoperative position, having moved through the progressive retraction sequence as illustrated in FIGS. 7A to 7D;

FIG. 9 is a perspective view similar to FIG. 3, showing a series of matched pairs of clamping assemblies of the type depicted in FIGS. 4 to 8, installed in spaced apart relationship along a section of a belt conveyor, in the operative position;

FIG. 10A is a perspective view of a clamping assembly according to a third embodiment of the invention, in the inoperative position;

FIG. 10B is a perspective view showing the clamping assembly of FIG. 10A, in the operative position; and

FIG. 11 is a perspective view showing a clamping assembly according to a fourth embodiment of the invention, in both the operative and inoperative positions (the inoperative position shown in ghost outline).

### PREFERRED EMBODIMENTS OF THE INVENTION

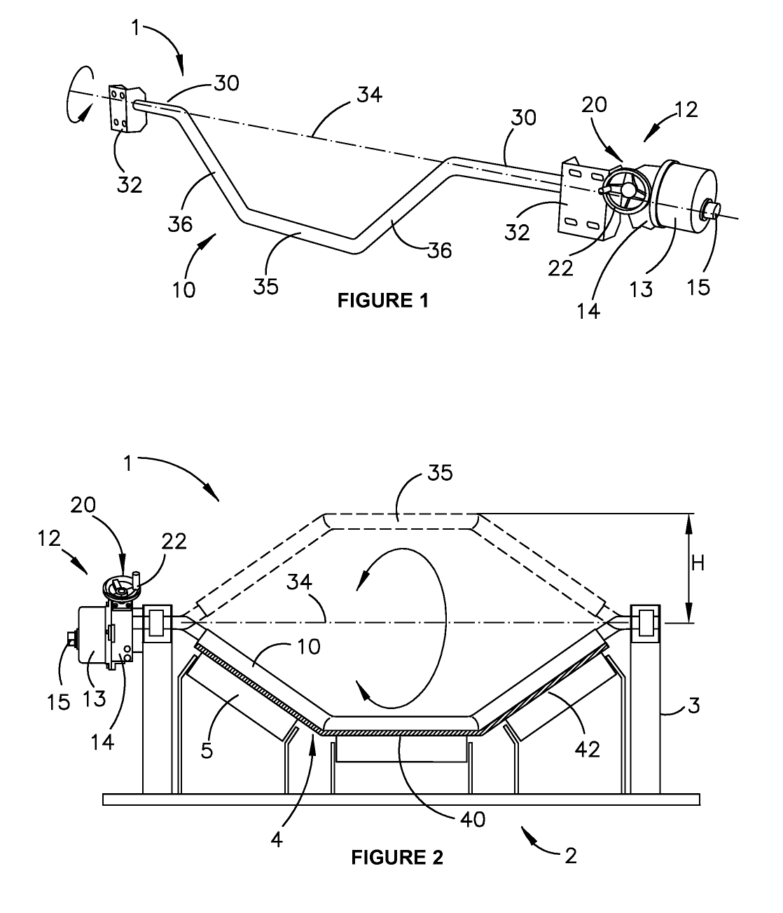

Referring initially to FIGS. 1 to 3, the invention in a first aspect provides, in a first embodiment, an automated clamping assembly 1 adapted for mounting on or adjacent a belt conveyor installation 2, typically in a relatively large scale outdoor application such as a mine, minerals processing plant, port loading facility or bulk freight transfer station. The conveyor installation 2 includes a support frame 3, a conveyor belt 4 and belt support rollers 5. Such belt conveyors are well known to those skilled in the art, and so will not be described in further detail.

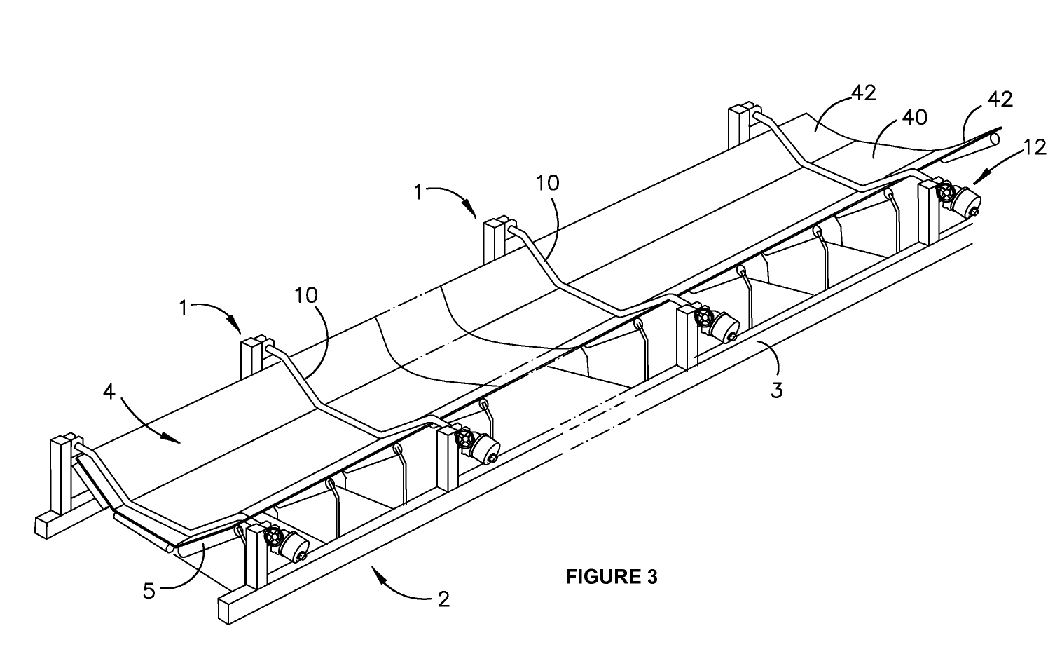

The clamping assembly 1 includes a clamping member in the form of a clamping arm 10 selectively movable between an operative position and an inoperative position. In the operative position, as best seen in FIGS. 2 and 3, the clamping arm is disposed on or closely adjacent the conveyor belt 4, so as to retain the belt in position during adverse weather conditions such as storms, cyclones or hurricanes. In the inoperative position, as best shown in ghost outline in FIG. 2, the clamping arm 10 is disposed well above and away from the conveyor belt, so as not to impede the conveyor belt, or material on the belt, during normal operation.

The clamping assembly 1 further includes an automated drive mechanism 12 comprising a drive motor 13 and a reduction gearbox 14 adapted to move the clamping arm between the operative and inoperative positions. This movement occurs in response to activation control signals received via a control module 15, which is operatively connected with the drive mechanism. The control module 15 is also adapted to generate feedback control signals indicative of the clamping status of the apparatus, and optionally other performance parameters of the drive mechanism, as described more fully below. In the embodiment shown, the drive motor 13 takes the form of an electric motor. It should be appreciated, however, that the drive mechanism may additionally or alternatively include an hydraulic motor or cylinder, a pneumatic motor or cylinder, an electromechanical actuator, a servomotor and/or other suitable powered drive means. In some embodiments (not shown) one drive mechanism is adapted to activate multiple clamping assemblies simultaneously.

The clamping assembly further includes a manual drive mechanism 20, operable independently as a backup and manual override for the automated drive mechanism 12, to effect manual movement of the clamping arm between the operative and inoperative positions. This allows manual operation of the clamp in emergency conditions, such as in the event of a motor failure or a total electrical power failure. In the embodiment shown, the manual drive mechanism 20 is operable by means of a rotary hand-wheel assembly 22, integrated with the reduction gearbox 14 associated with the automated drive mechanism 12.

Turning now to describe the clamping arrangement in more detail, and again with reference to FIGS. 1 to 3, the clamping arm 10 in this embodiment is adapted to extend transversely across the entire width of the conveyor belt and is therefore particularly suited to long open type conveyors, where no stackers run over the belt.

As best seen in FIG. 1, the clamping arm includes end sections 30 supported by bearing blocks 32 for rotational movement about a generally horizontal transverse pivot axis 34, and a central belt retaining section 35 which is axially spaced from, but generally parallel to, the pivot axis 34. Intermediate shoulder sections 36 are disposed on either side of the central section 35, so as to connect the central section with the respective end sections 30 of the clamping arm.

Thus, in the operative position, the central section of the clamping arm is in direct contact with, or at least in close proximity to, a central region 40 of the conveyor belt, so as to prevent the belt from lifting to any substantial degree in high wind conditions. If the belt has inclined side regions 42 of the type shown in FIGS. 2 and 3, the intermediate shoulder sections 36 of the clamping arm are ideally inclined at corresponding angles in the operative position, such that the side regions 42 of the belt are also clamped by the respective shoulder sections 36 of the clamping arm.

As best seen in FIG. 2, the clamping arm is shaped to allow bulk material on the belt to pass beneath the central portion of the arm during normal operation of the conveyor, with the clamping assembly in the inoperative position. In particular, it will be appreciated that the height of bulk material on the belt that may pass beneath the clamping arm in the inoperative position is equal to twice the height of the vertical arrow H as indicated in FIG. 2.

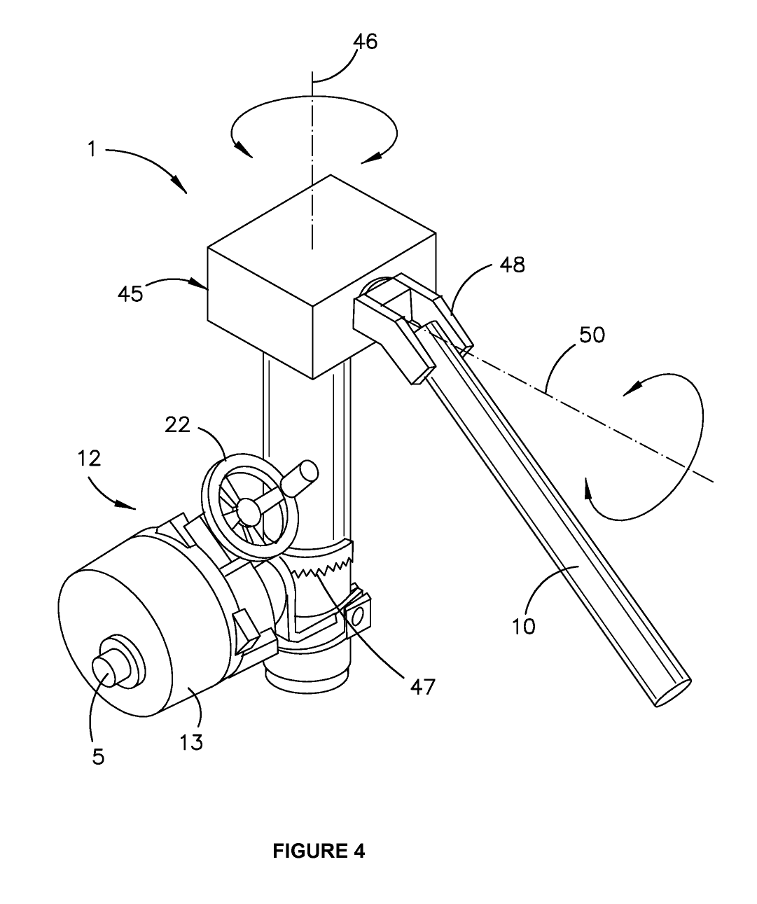

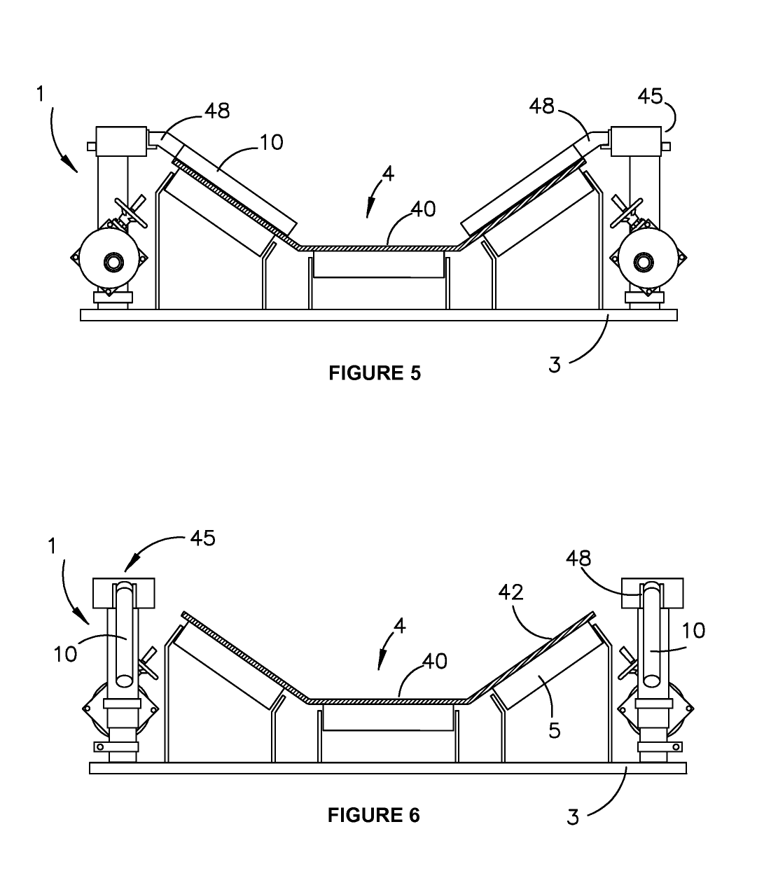

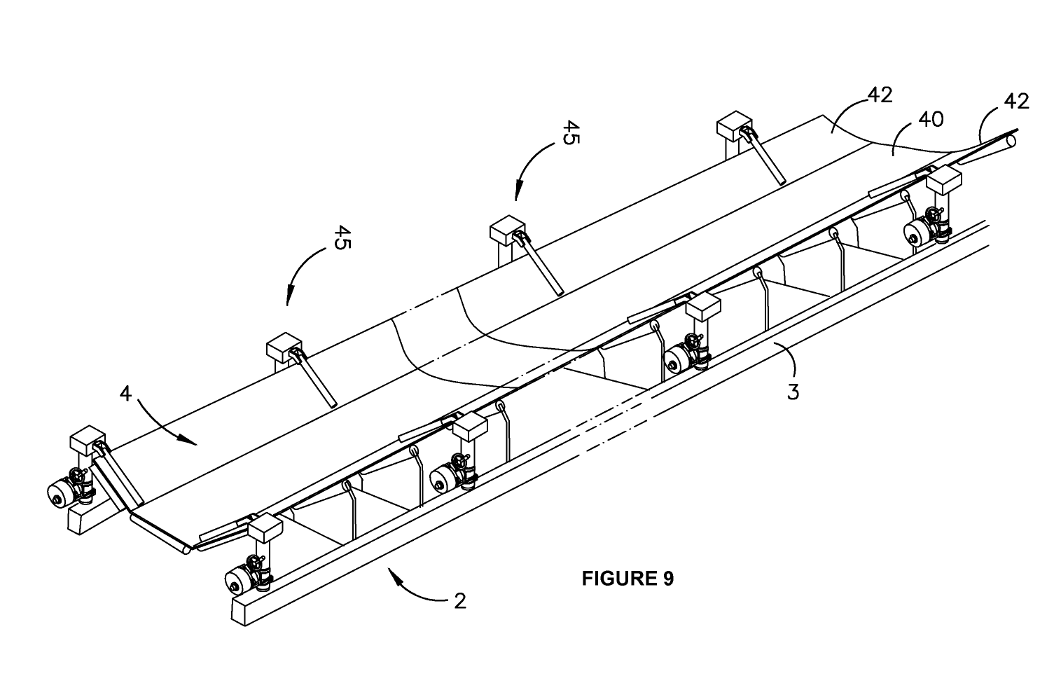

A second embodiment of the invention is shown in FIGS. 4 to 9, wherein similar features are denoted by corresponding reference numerals. In this embodiment, the clamping member takes the form of a relatively short clamping arm 10 adapted in use to extend only partially across the conveyor belt 4, so as to clamp only one side of the belt. These clamping assemblies are thereby adapted for use in matched pairs, disposed on opposite sides of the conveyor, with their respective clamping arms adapted for engagement with corresponding opposite side regions 42 of the belt in the operative position, as best seen in FIGS. 5 and 9. If the belt has inclined side regions as shown, the arm of each clamping assembly is preferably inclined at a generally corresponding angle, in the operative position. It should be appreciated, however, that in conveyor installations with flat belts, the clamping arms may be similarly shaped and oriented (i.e. oriented generally horizontally when operative), for optimal clamping engagement. It should also be appreciated that in some embodiments (not shown) the engagement arms may not directly contact the belt. Rather, the arms may be adapted to support engagement feet, shoes, lugs or other suitable engagement formations, in which case such formations should be understood to form an extended part of the clamping member or clamping arm in the present context.

In this embodiment, movement between the operative and inoperative positions involves pivotal movement of the clamping arm about orthogonal axes in several stages, regulated by or through the control module, or by a sequence of internal limit switches. As best seen in FIG. 4, this movement is effected by the drive motor, through rotation of the entire turret assembly 45 about a first generally vertical pivot axis 46 via external rack and pinion gears 47, in combination with independent rotation of an angled clamping arm support bracket 48 about a second generally horizontal pivot axis 50. Movement of the clamping arm support bracket 48 about the second pivot axis 50 is effected by a gear train (not shown), or alternatively by a servo motor or other suitable drive means, ideally housed within the turret assembly itself.

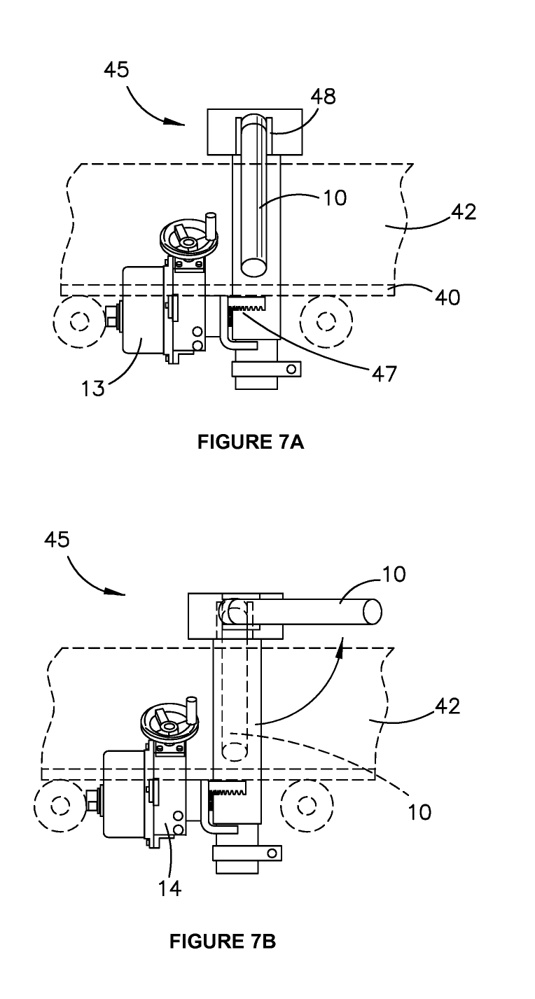

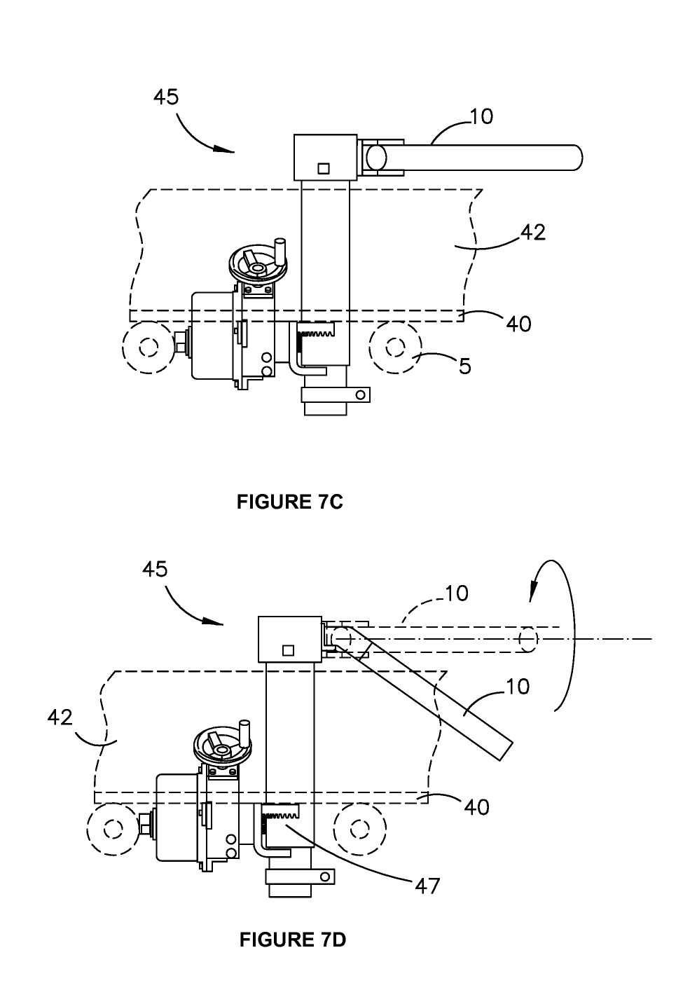

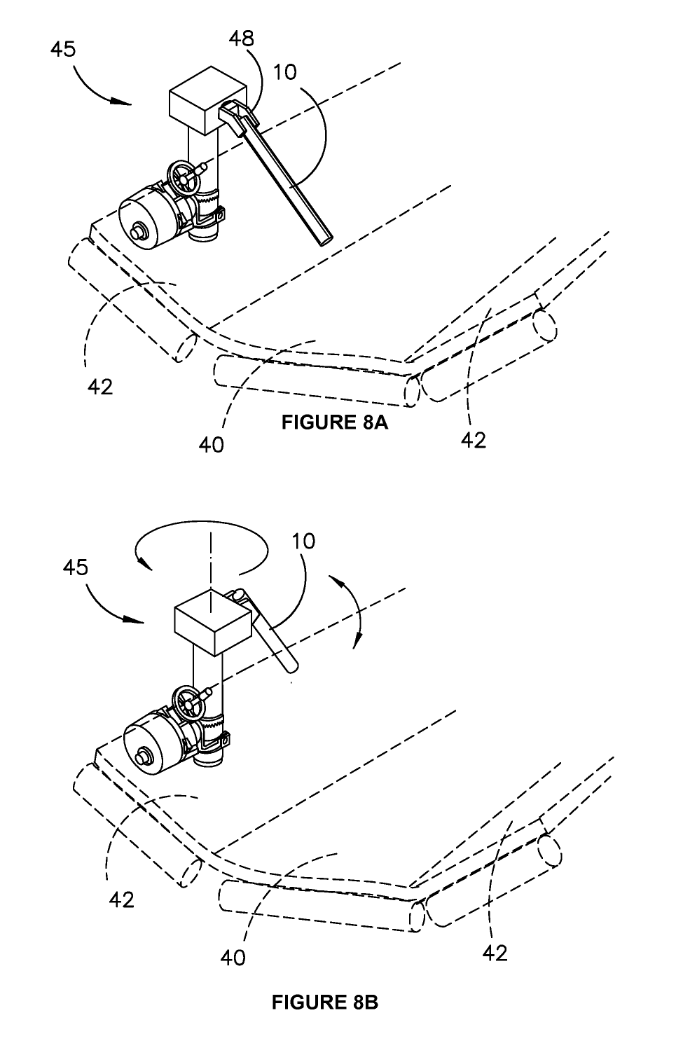

More specifically, the retraction sequence begins with the clamping assembly in the operative position, as shown in FIG. 7A. From there, the first stage of movement toward the inoperative position involves rotational displacement of the clamping arm 10 and associated angled support bracket 48 through 90° in an anticlockwise direction (when viewing the drawing) about the horizontal pivot axis 50, which at this stage is oriented transversely with respect to the belt. In this way, the arm is disengaged from the side region 42 of the belt and rotated into a horizontal orientation above the belt, as best seen in FIG. 7B. The second stage of movement involves rotational displacement of the entire turret assembly 45 through an angle of 90° in an anticlockwise direction (when viewed from above) about the generally vertical pivot axis 46. In this way the arm, still in a horizontal orientation, is moved to a position alongside the belt, as best seen in FIG. 7C. The third stage of movement involves further rotation of the clamping arm and associated angled support bracket 48 through 90° about the horizontal pivot axis 50 (this axis now being generally parallel to the orientation of the belt as a result of the previous rotation of the turret) so that the clamping arm is inclined downwardly, in a plane that is generally parallel to but displaced away from the belt, as best seen in FIG. 7D (see also FIGS. 6 and 8). Movement from the inoperative to the operative position is essentially the reverse of this sequentially staged procedure.

One significant advantage of this configuration is that when the clamping arm is fully retracted into the inoperative position, the space above the belt is totally free from obstruction, so that stackers or reclaimers can be readily accommodated. Furthermore, when fully retracted the clamping assembly occupies minimal space and can be readily accommodated within the spatial confines of most conveyor support frames.

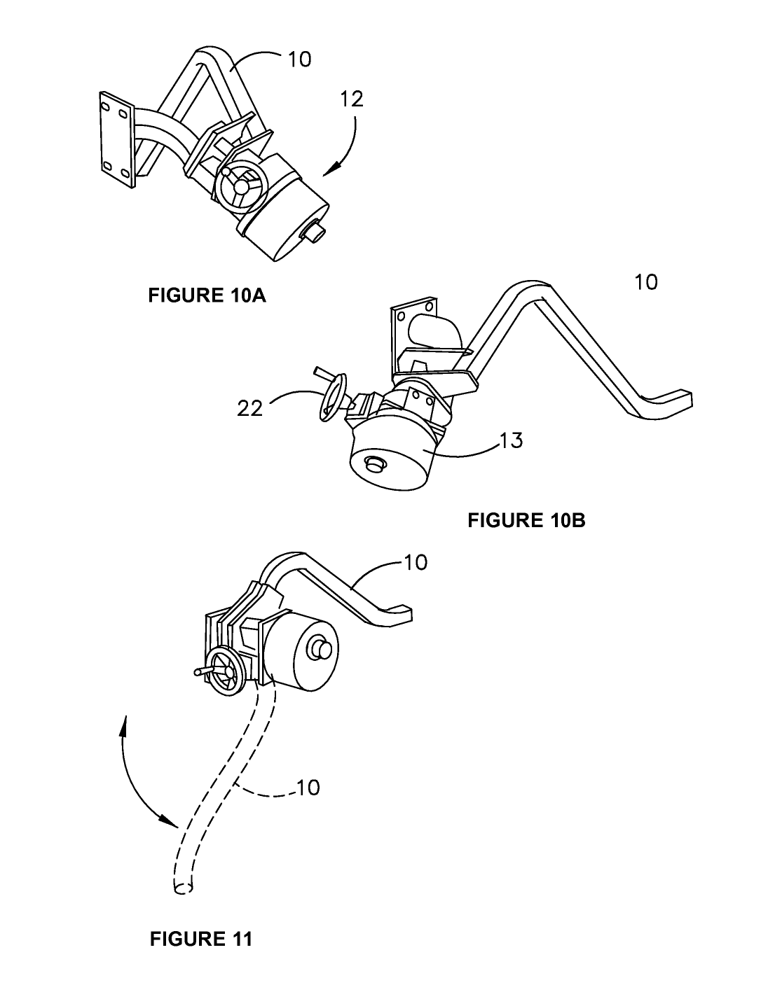

A third embodiment of the invention is shown in FIGS. 10A and 10B, wherein again, similar features are denoted by corresponding reference numerals. This embodiment operates in matched pairs, in a similar way to that described above in relation to the second embodiment of the invention. The inoperative retracted position is shown in FIG. 10A, and the operative position is shown in FIG. 10B, with movement therebetween occurring in sequential rotational stages analogous to those previously described. Again, the compact form of this arrangement in both the operative and inoperative positions, as well as during the transitional stages, will be evident.

A fourth embodiment of the invention is shown in FIG. 11, which is a simpler variation of the embodiment of FIG. 10. In this case, movement between the operative position and the inoperative position (shown in ghost outline) is simply effected by approximately 270° of rotational displacement about a horizontal axis extending generally parallel to the conveyor belt. This arrangement has the advantage of relative simplicity but occupies a larger spatial envelope adjacent the conveyor, particularly during the transitional stages of movement.

In these and other embodiments, the clamping assembly may be readily adapted for retrofitting to existing belt conveyor installations. Alternatively, however, the clamping assembly can be fully integrated into the conveyor and related control systems at the design stage.

A second aspect of the invention involves installing a series of clamping assemblies in spaced apart relationship along the length of a belt conveyor or conveyor section, together with a system controller adapted selectively to activate and deactivate the individual clamping assemblies. The system controller is thereby able automatically to regulate movement of each clamping assembly between the operative and inoperative positions, by means of appropriate activation control signals. Examples of such arrangements as shown in FIG. 3 (in relation to the first embodiment) and FIG. 9 (in relation to the second embodiment) of the invention.

In some embodiments, the control signals are generated by the system controller in response to direct inputs from a human operator, for example via a main activation control switch, control panel or other suitable user interface within a control room. In more sophisticated embodiments, however, the activation control signals may be generated by the system controller automatically in response to predetermined control parameters such as minimum threshold wind speed or wind loading conditions, forecast storm conditions, automated timing intervals, preprogrammed testing or maintenance intervals, and the like. Moreover, more sophisticated implementations permit remote control via a web based interface.

Within such systems, the clamping assemblies may be grouped, for example, with each group being associated with a predetermined segment or section of the conveyor, and each group being independently controllable via the system controller. In some installations, each clamping assembly is individually and discretely operable remotely, via the system controller. The controller may be readily programmed to activate the respective clamping assemblies in the system simultaneously, in clustered subsets, sequentially, or in other staged ways, so as to minimise electrical current load spikes or otherwise to enhance control flexibility, redundancy or efficiency.

The system controller is also adapted to receive feedback control signals from the individual control modules 15 associated with the respective clamping assemblies. These feedback control signals provide an indication, via an output display terminal, to an operator in a remote control room (or at a remote location via a web interface) as to the clamping status of the respective clamping assemblies. In one form, the display terminal provides a visual indication, for example a digital display or an illuminated indicator light, in relation to each clamping assembly, indicative of when the respective clamp is in the operative or the inoperative position. In some embodiments, more detailed information may be incorporated into the feedback control signals, to indicate the specific intermediate orientation, stage or position of each clamping arm, between the operative and inoperative positions. Importantly, this feedback mechanism allows a remote operator to readily determine if any of the clamping assemblies in the system is malfunctioning (for example by failing to move fully into the operative or inoperative position when required) and if so, which particular clamping assemblies (or groups of assemblies) are affected.

The feedback control signals may also include further information indicative of elements of system performance, such as the electrical current drawn by the individual drive motors. Such information may then be used by diagnostic systems or software within the main system controller to identify faults with individual clamping units. For example, excessive current draw may be indicative of imminent failure of a drive motor, a short circuit in a motor controller, or a physical obstacle in the path of the associated clamping arm. This level of diagnostic information will often allow problems to be identified and rectified before a total failure of a clamping assembly occurs and even in the event of a complete failure, the condition can be identified immediately and the precise location of the problem unit can be readily pinpointed.

Advantageously, the invention at least in its preferred forms, provides a number of significant advantages. First and foremost, the risk of injury to personnel is substantially reduced if not eliminated, as many kilometres of conveyor can locked down automatically in minutes following the press of a button in a remote control room, without requiring any operators to venture outside into typically wet, windy and dangerous conditions.

Furthermore, the cost savings as a result of reduced downtime are potentially enormous. Typically, production would be increased by 4 to 6 hours on either side of a storm or cyclone and because the whole process can be completed within minutes, unnecessary lockdowns can be avoided. The savings due to this alone could amount to many millions of dollars per year in a typical large scale installation at a single site. Further, the risk of human error is substantially eliminated, as there is no possibility of incorrect fitting or removal of manual clamping devices and hence the consequential damage to plant and equipment that can result from such errors or oversights, particularly in the event of a chain or manual clamp being inadvertently overlooked during the unlocking procedure.

Regular maintenance costs are also substantially reduced, as routine operational checks can be performed in minutes via the central system controller based on the feedback control signals from the individual control modules, during scheduled plant or conveyor shutdowns. Moreover, some faults are detectable during normal operation, for example, as a result of abnormal electrical current draw in a particular clamping unit. Performance anomalies or deteriorating performance trends based on such parameters can also be used to predict potential problems and schedule required maintenance at optimal times, again leading to reduced maintenance costs and unscheduled downtime. In these and other respects, the invention represents a practical and commercially significant improvement over the prior art.

Although the invention has been described with reference to specific examples, it will be appreciated by those skilled in the art that the invention may be embodied in many other forms.

I claim:

1. An automated clamping assembly adapted for mounting on or adjacent a belt conveyor, the clamping assembly including:
a clamping member selectively movable between an operative position in which the clamping member is disposed on or closely adjacent a conveyor belt to retain the belt in a rest position during adverse weather conditions, and an inoperative position in which the clamping member is disposed away from the conveyor belt so as not to impede normal operation of the conveyor belt; and
an automated drive mechanism adapted to move the clamping member between the operative position and the inoperative position.

2. A clamping assembly according claim 1, further including a control module adapted to activate the drive means in response to activation control signals.

3. A clamping assembly according to claim 2, wherein the control module is adapted to generate feedback control signals indicative of a clamping status of the clamping member.

4. A clamping assembly according to claim 3, wherein the feedback control signals verify when the clamping member is in the operative position, and/or when the clamping member is in the inoperative position.

5. A clamping assembly according to claim 3, wherein the feedback control signals include information indicative of the position of the clamping member between the operative and inoperative positions.

6. A clamping assembly according to claim 3, wherein the feedback control signals include information indicative of operating performance parameters associated with the drive mechanism, on the basis of which errors signals are generated in the event of such parameters extending beyond predetermined threshold levels.

7. A clamping assembly according to claim 1, further including a manual drive mechanism operable independently as a back-up to the automated drive mechanism, to effect manual movement of the clamping member between the operative and inoperative positions and wherein the drive mechanism includes one or more drive elements selected from a group comprising hydraulic motors and cylinders, pneumatic motors and cylinders, servomotors, and electromechanical actuators.

8. (canceled)

9. (canceled)

10. (canceled)

11. A clamping assembly according to claim 1, wherein the drive mechanism is adapted to activate multiple clamping assemblies simultaneously.

12. A clamping assembly according to claim 1, wherein the clamping member includes a clamping arm adapted in use to extend transversely across the conveyor belt.

13. A clamping assembly according to claim 12, wherein the clamping arm is supported for rotational movement about a generally horizontal transverse pivot axis between the operative and inoperative positions.

14. A clamping assembly according to claim 12, wherein the clamping arm includes respective end sections which in use are substantially coaxial with the pivot axis, a central belt retaining section which is axially spaced from the pivot axis, and intermediate shoulder sections which are disposed on either side of the central section to connect the central section with the respective end sections, wherein in the operative position, the central belt retaining section is in contact with, or in close proximity to, the conveyor belt so as to prevent the belt from substantially lifting.

15. (canceled)

16. (canceled)

17. A clamping assembly according to claim 14, wherein the clamping arm is shaped so as to allow bulk material on the belt to pass beneath the central section during normal operation of the conveyor, with the clamping member in the inoperative position.

18. A clamping assembly according to claim 14, wherein the belt has inclined side regions, and wherein the intermediate shoulder sections of the clamping arm are respectively inclined at generally corresponding angles in the operative position.

19. A clamping assembly according to claim 1, wherein the clamping member includes a relatively short clamping arm adapted in use to extend only partially across the conveyor belt, so as to clamp one side of the belt.

20. A clamping assembly according to claim 19, adapted for use as part of a matched pair of like clamping assemblies disposed on opposite sides of the conveyor belt, with the respective clamping arms adapted for engagement with opposite sides of the belt, in the operative position.

21. A clamping assembly according to claim 20, wherein the belt has inclined side regions, and wherein the respective clamping arm of each clamping assembly is inclined at a generally corresponding angle, in the operative position.

22. A clamping assembly according to claim 19, wherein movement between the operative and inoperative positions involves pivotal movement of the clamping arm about generally orthogonal axes in at least two stages, wherein the first stage of pivotal movement involves rotational displacement about a generally horizontal transverse axis whereby the arm is positioned above the corresponding side of the belt, and wherein the second stage of pivotal movement involves subsequent rotational displacement about a generally vertical axis whereby the clamping arm is moved to one side of the belt.

23. (canceled)

24. A clamping assembly according to claim 22, including a third stage of pivotal movement, whereby the clamping arm is subsequently rotationally displaced about a substantially horizontal axis generally aligned with the belt, and thereby lowered into a retracted inoperative position on one side of the belt.

25. A clamping assembly according to claim 1, wherein movement of the clamping member between the operative and inoperative positions involves a single stage of rotational displacement about a generally horizontal axis which is generally aligned with a directional orientation of the belt.

26. A clamping assembly according to claim 1, wherein the clamping arm is adapted to be retracted, in one or more phases of pivotal and/or translational displacement, so as to reside substantially within the confines of a supporting frame for the belt conveyor in the inoperative position.

27. (canceled)

28. A clamping system for a belt conveyor, the system including:
a plurality of clamping assemblies, each as defined in accordance with claim 1, and adapted in use to be disposed in spaced apart relationship along the belt conveyor; and
a system controller adapted selectively to activate and deactivate the clamping assemblies, thereby automatically to regulate movement of the respective clamping members between the operative and inoperative positions, by means of activation control signals transmitted to the control modules of the respective clamping assemblies.

29. A clamping system according to claim 28, wherein the activation control signals are generated by the system controller in response to inputs from a human operator, via a main activation control panel and by the system controller automatically in response to predetermined control parameters.

30. (canceled)

31. (canceled)

32. (canceled)

33. A clamping system according to claim 28, wherein the system controller is adapted to activate the clamping assemblies simultaneously.

34. (canceled)

35. A clamping system according to claim 28, wherein the system controller is adapted to receive feedback control signals from the control modules associated with the respective clamping assemblies, and to provide an indication via a display terminal to an operator of the clamping status of one or more of the clamping assemblies.

36. A clamping system according to claim 35, wherein the display terminal is adapted to provide a visual indication of when each of the respective clamping assemblies is in the operative position and/or the inoperative position.

37. A clamping system according to claim 35, wherein the feedback control signals include information indicative of one or more operational performance parameters of the respective clamping assemblies, and wherein the system controller is adapted to generate a warning signal if any of the operational performance parameters extend beyond predetermined normal operating threshold levels.

38. A method for remotely clamping a belt conveyor so as to lock down the conveyor in adverse weather conditions, the method including the steps of:
providing a clamping system as defined in accordance with claim 28;
positioning the clamping assemblies of the clamping system in spaced apart relationship along a segment of the conveyor, and
activating the system controller of the clamping system remotely so as to cause the clamping assemblies to move automatically between the operative and inoperative positions, according to selective operator control inputs or predetermined control parameters.

39. (canceled)

40. (canceled)

41. (canceled)
